(19) United States
(12) Patent Application Publication
(10) Pub. No.: US 2018/0308443 A1
(43) Pub. Date: Oct. 25, 2018

(54) VIDEO SIGNAL LINE DRIVE CIRCUIT AND DISPLAY DEVICE PROVIDED WITH SAME

(71) Applicant: Sharp Kabushiki Kaisha, Sakai City, Osaka (JP)

(72) Inventors: Maremu YAMAGISHI, Sakai City (JP); Masaaki NISHIO, Sakai City (JP); Kazuo NAKAMURA, Sakai City (JP)

(21) Appl. No.: 15/769,407

(22) PCT Filed: Oct. 17, 2016
(86) PCT No.: PCT/JP2016/080644

§ 371 Date: Apr. 19, 2018

(30) Foreign Application Priority Data
Oct. 23, 2015 (JP) 2015-208591

(51) Int. Cl. G09G 3/36

(52) U.S. Cl. CPC G09G 3/3648; G09G 2320/0613; G09G 2380/10; G09G 3/3685

(57) ABSTRACT

A source driver is provided that can suppress the occurrence of abnormal display caused by “the difference in the settling time of a data voltage (to be applied to a source bus line)” depending on location of source bus lines. The source driver includes a data voltage generating unit (31) that generates data voltages corresponding to display gradations; output amplifiers (32) that output the data voltages to the source bus lines; a register (33) that stores control values (C) for adjusting the settling time of outputs of the data voltages from the output amplifiers (32); and a bias current control unit (34) that controls the magnitudes of bias currents of the output amplifiers (32) based on the control values (C) stored in the register (33).

### TECHNICAL FIELD

The present invention relates to a display device and more particularly to a video signal line drive circuit that drives video signal lines of particularly a display device having a display panel especially having a shape other than a rectangle.

### BACKGROUND ART

A liquid crystal display device generally includes a liquid crystal panel composed of two insulating glass substrates facing each other. One of the glass substrates is called an array substrate and the other is called a counter substrate. The array substrate has thin film transistors (TFTs), pixel electrodes, etc., formed thereon, and the counter substrate has a counter electrode, color filters, etc., formed thereon. Such a conventional general liquid crystal panel has a rectangular display unit (display region). In the display unit there are formed a plurality of source bus lines (video signal lines), a plurality of gate bus lines (scanning signal lines), and a plurality of pixel formation portions provided at the respective intersections of the plurality of source bus lines and the plurality of gate bus lines. Each pixel formation portion includes a TFT connected at its gate electrode to a gate bus line passing through a corresponding intersection, and connected at its source electrode to a source bus line passing through the intersection; a pixel electrode connected to a drain electrode of the TFT; a counter electrode and an auxiliary capacitance electrode which are provided so as to be shared by the plurality of pixel formation portions; a liquid crystal capacitance formed by the pixel electrode and the counter electrode; and an auxiliary capacitance formed by the pixel electrode and the auxiliary capacitance electrode. By the liquid crystal capacitance and the auxiliary capacitance, a pixel capacitance is formed. In a configuration such as that described above, a pixel capacitance is charged based on a data voltage (video signal) which is received from a source bus line by the source electrode of a TFT when the gate electrode of the TFT receives an active scanning signal from a gate bus line. By thus charging the pixel capacitances in the plurality of pixel formation portions, a desired image is displayed on the display unit.

In a liquid crystal display device such as that described above, luminance non-uniformity may occur due to, for example, the placement of light sources forming a backlight. Hence, conventionally, in order to suppress the occurrence of luminance non-uniformity, a data voltage corresponding to a target display gradation is corrected and the corrected data voltage is applied to a source bus line. An invention of a liquid crystal display device that performs such correction is disclosed in, for example, Japanese Laid-Open Patent Publication No. 2008-70404.

### PRIOR ART DOCUMENT

### Patent Document

[Patent Document 1] Japanese Laid-Open Patent Publication No. 2008-70404

### SUMMARY OF THE INVENTION

### Problems to be Solved by the Invention

As described above, the conventional general liquid crystal panel has a rectangular display unit (display region). However, in recent years, the development of liquid crystal display devices including a display unit having a shape other than a rectangle, such as a liquid crystal display device for clock application and a liquid crystal display device for in-vehicle application, has progressed. Note that in the following a display device including a display unit having a shape other than a rectangle and including a display panel whose outer shape is also other than a rectangle is referred to as “oddly shaped display”.

Meanwhile, in the oddly shaped display, despite the fact that a target display image is so-called a “solid image” (an image that provides the same color and the same gradation in the entire display unit), the actual display image is an image called vertical gradation (an image whose gradation gradually changes in a horizontal direction). Such abnormal display will be described with reference to FIGS. 19 and 20.

FIG. 19 is a diagram schematically showing source bus lines, a display unit, and a source driver of an oddly shaped display having a circular display unit. As can be grasped from FIG. 19, in this oddly shaped display, the length of the source bus lines varies depending on location. For example, while the length of a source bus line denoted by reference character 91 (a source bus line disposed at an edge portion of the display unit) is relatively short, the length of a source bus line denoted by reference character 92 (a source bus line disposed at a location close to a central portion of the display unit) is relatively long. In addition, in a region in the display unit, each source bus line is connected to the above-described pixel formation portions. That is, while the source bus line denoted by reference character 91 is connected to a comparatively small number of pixel formation portions, the source bus line denoted by reference character 92 is connected to a comparatively large number of pixel formation portions. By the above, the load on the source bus line denoted by reference character 91 is relatively small, and the load on the source bus line denoted by reference character 92 is relatively large. Hence, for example, while the signal waveform of a data voltage changes as indicated by reference character Va in FIG. 20 at the source bus line denoted by reference character 91, the signal waveform of a data voltage changes as indicated by reference character Vb in FIG. 20 at the source bus line denoted by reference character 92.

It can be grasped from FIG. 20 that a source bus line disposed at a location closer to the central portion of the display unit has longer settling time (the time taken for a voltage value to converge to an allowable range of a target value) of a data voltage (i.e., slow response speed). Such a difference in the settling time of a data voltage causes a difference in charging rate depending on location (location in the horizontal direction). As a result, an image called vertical gradation is displayed (despite the fact that a target display image is a solid image). That is, abnormal display occurs.

An object of the present invention is therefore to provide a source driver (video signal line drive circuit) capable of suppressing the occurrence of abnormal display caused by “the difference in the settling time of a data voltage (to be applied to a source bus line)” depending on location of the source bus lines (video signal lines), and a display device including the source driver.

### Means for Solving the Problems

A first aspect of the present invention is directed to a video signal line drive circuit for driving video signal lines, the video signal line drive circuit including:

a data voltage generating unit configured to generate data voltages corresponding to display gradations;

a number of output amplifiers equal to a number of the video signal lines, the output amplifiers being configured to output the data voltages to the video signal lines;

a storage unit configured to store control values for adjusting settling time of outputs of the data voltages from the output amplifiers; and

a bias current control unit configured to control magnitudes of bias currents of the output amplifiers based on the control values stored in the storage unit.

According to a second aspect of the present invention, in the first aspect of the present invention,

the storage unit stores a number of the control values equal to the number of the video signal lines, and

the bias current control unit controls, on a per video signal line basis, a magnitude of a bias current of a corresponding output amplifier based on a corresponding one of the plurality of control values stored in the storage unit.

A third aspect of the present invention is directed to a display device including:

a display panel having video signal lines; and

a video signal line drive circuit according to a third aspect of the present invention.

According to a fourth aspect of the present invention, in the third aspect of the present invention,

a shape of the display panel is non-rectangular, and

control values are stored in the storage unit such that a bias current control unit increases a magnitude of a bias current more for an output amplifier provided for a video signal line with a longer length.

According to a fifth aspect of the present invention, in the fourth aspect of the present invention,

the shape of the display panel is circular.

According to a sixth aspect of the present invention, in the fourth aspect of the present invention,

the shape of the display panel is circular.

According to a seventh aspect of the present invention, in the fourth aspect of the present invention,

the shape of the display panel is rectangular, and

the control values are stored in the storage unit such that the bias current control unit increases a magnitude of a bias current more for an output amplifier provided for a video signal line whose charging rate is lower when it is assumed that data voltages of a same magnitude are applied to all the video signal lines without controlling magnitudes of bias currents of output amplifiers.

An eighth aspect of the present invention is directed to a method for driving video signal lines by a video signal line drive circuit having a number of output amplifiers equal to a number of video signal lines, the method comprising:

a data voltage generating step of generating data voltages corresponding to display gradations;

a data voltage outputting step of outputting the data voltages to the video signal lines from the output amplifiers; and

a bias current controlling step of controlling magnitudes of bias currents of the output amplifiers based on control values set in advance to adjust settling time of outputs of the data voltages from the output amplifiers.

### Effects of the Invention

According to the first aspect of the present invention, the video signal line drive circuit is provided with a storage unit that stores control values for adjusting settling time of outputs of data voltages from the output amplifiers, and a bias current control unit that controls the magnitudes of bias currents of the output amplifiers based on the control values stored in the storage unit, in addition to conventional components. Hence, by suitably storing control values in the storage unit taking into account the load on each video signal line, the magnitude of a bias current of each output amplifier is controlled so as to reduce the difference in the settling time of an output of a data voltage from each output amplifier between the plurality of video signal lines. By this, in a display device including the video signal line drive circuit, the charging rate becomes uniform across the display unit, and the occurrence of abnormal display (display of an image called vertical gradation) is suppressed. As such, the video signal line drive circuit is implemented that can suppress the occurrence of abnormal display caused by “the difference in the settling time of a data voltage (to be applied to a video signal line)” depending on location of the video signal lines.

According to the second aspect of the present invention, on a per video signal line basis, the magnitude of bias current of a corresponding output amplifier is controlled. Hence, the occurrence of abnormal display (display of an image called vertical gradation) is effectively suppressed.

According to the third aspect of the present invention, a display device is implemented that includes a video signal line drive circuit that can suppress the occurrence of abnormal display caused by “the difference in the settling time of a data voltage (to be applied to a video signal line)” depending on location of the video signal lines.

According to the fourth aspect of the present invention, in a display device including a non-rectangular display panel, control values are stored in the storage unit such that a larger bias current flows through an output amplifier provided for a video signal line with a larger load. Hence, the difference in the settling time of an output of a data voltage from each output amplifier between the plurality of video signal lines is reduced. By this, in the display device including a non-rectangular display panel, the charging rate becomes uniform across the display unit, and the occurrence of abnormal display (display of an image called vertical gradation) is suppressed.

According to the fifth aspect of the present invention, in a display device having a circular display panel, the same effect as that of the fourth aspect of the present invention can be obtained.

According to the sixth aspect of the present invention, in a display device for in-vehicle use, the same effect as that of the fourth aspect of the present invention can be obtained.

According to the seventh aspect of the present invention, in a display device including a rectangular display panel, control values are stored in the storage unit such that a larger bias current flows through an output amplifier provided for a video signal line whose charging rate is lower in a case where the magnitudes of bias currents are not controlled. By this, in the display device including a rectangular display panel, the occurrence of luminance non-uniformity is suppressed.

According to the eighth aspect of the present invention, the same effect as that of the first aspect of the present invention can be obtained in the video signal line drive method.

### BRIEF DESCRIPTION OF THE DRAWINGS

FIG. 1 is a block diagram showing a detailed configuration of a source driver of a liquid crystal display device according to one embodiment of the present invention.

FIG. 2 is a block diagram showing an overall configuration of the liquid crystal display device according to the embodiment.

FIG. 3 is a diagram for describing a display unit of the embodiment.

FIG. 4 is a diagram showing a configuration of a pixel formation portion in the embodiment.

FIG. 5 is a diagram for describing gate drivers of the embodiment.

FIG. 6 is a diagram for describing a register of the embodiment.

FIG. 7 is a diagram for describing another example of a register of the embodiment.

FIG. 8 is a diagram showing a configuration of an output amplifier corresponding to one source bus line in the embodiment.

FIG. 9 is a diagram showing an exemplary configuration of a differential amplifier included in an operational amplifier in the embodiment.

FIG. 10 is a circuit diagram showing an example of an overall configuration of the operational amplifier in the embodiment.

FIG. 11 is an example of a signal waveform diagram of a data voltage for when the magnitude of a bias current of an output amplifier is set to 40% in the embodiment.

FIG. 12 is an example of a signal waveform diagram of a data voltage for when the magnitude of the bias current of the output amplifier is set to 100% in the embodiment.

FIG. 13 is a diagram for describing the difference in the length of source bus lines depending on location of the source bus lines in the embodiment.

FIG. 14 is a diagram for describing the control of the magnitudes of bias currents in the embodiment.

FIG. 15 is a front view of a liquid crystal display device for in-vehicle use according to a first variant of the embodiment.

FIG. 16 is a diagram for describing the control of the magnitudes of bias currents in the first variant of the embodiment.

FIG. 17 is a block diagram showing an overall configuration of a liquid crystal display device according to a second variant of the embodiment.

FIG. 18 is a diagram for describing the control of the magnitudes of bias currents in the second variant of the embodiment.

FIG. 19 is a diagram schematically showing source bus lines, a display unit, and a source driver of an oddly shaped display having the circular display unit regarding conventional art.

FIG. 20 is a signal waveform diagram for describing the difference in the settling time of a data voltage depending on location of the source bus lines for the conventional art.

### MODE FOR CARRYING OUT THE INVENTION

One embodiment of the present invention will be described below with reference to the accompanying drawings.

<1. Overall Configuration and Operation Overview>

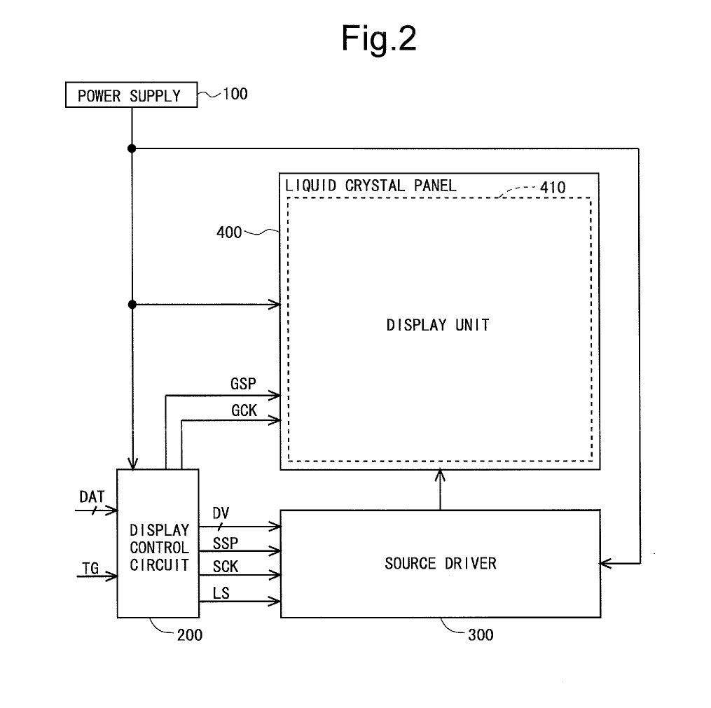

FIG. 2 is a block diagram showing an overall configuration of a liquid crystal display device according to one embodiment of the present invention. As shown in FIG. 2, the liquid crystal display device includes a power supply 100, a display control circuit 200, a source driver (video signal line drive circuit) 300, and a liquid crystal panel 400. The liquid crystal panel 400 includes a display unit (display region) 410 that displays an image. Note that, although the liquid crystal panel 400 and the display unit 410 are shown as rectangles since FIG. 2 is a block diagram, the shapes of the liquid crystal panel 400 and the display unit 410 are circular in the liquid crystal display device according to the present embodiment. That is, the liquid crystal display device according to the present embodiment is an oddly shaped display.

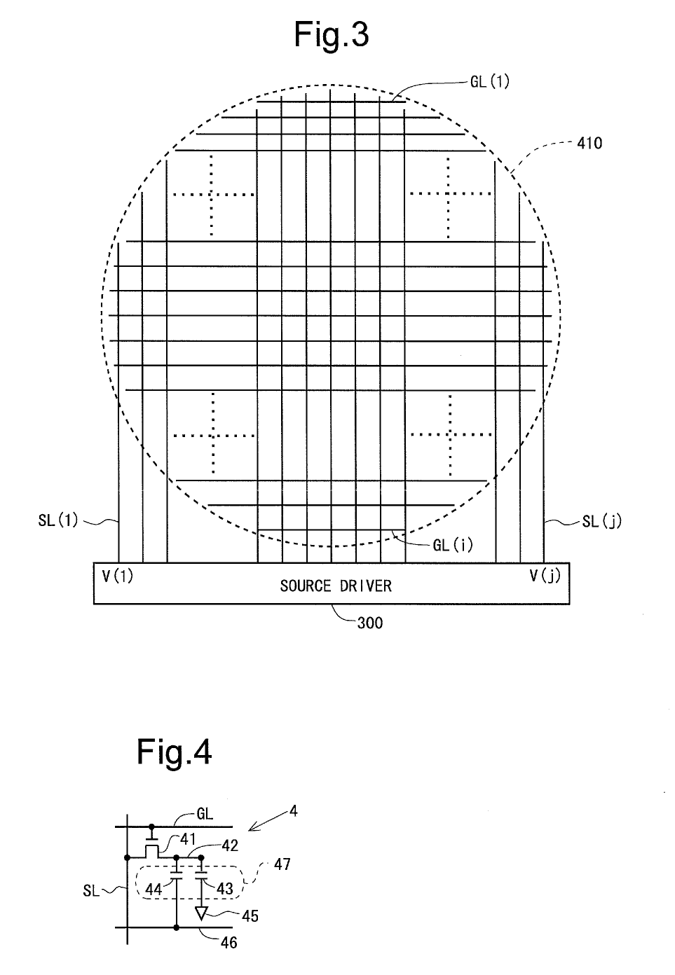

FIG. 3 is a diagram for describing the display unit 410 of the present embodiment. In the display unit 410, as shown in FIG. 3, there are disposed a plurality of (j) source bus lines (video signal lines) SL(1) to SL(j) and a plurality of (i) gate bus lines (scanning signal lines) GL(1) to GL(i). For example, j is 1920 and i is 1080. In addition, in a region in the display unit 410, pixel formation portions each forming a pixel are provided near the respective intersections of the source bus lines SL and the gate bus lines GL.

FIG. 4 is a circuit diagram showing a configuration of a pixel formation portion 4. The pixel formation portion 4 includes a thin film transistor (TFT) 41 connected at its gate terminal to a gate bus line GL passing through a corresponding intersection, and connected at its source terminal to a source bus line SL passing through the intersection; a pixel electrode 42 connected to a drain terminal of the TFT 41; a counter electrode 45 and an auxiliary capacitance electrode 46 which are provided so as to be shared by the plurality of pixel formation portions 4; a liquid crystal capacitance 43 formed by the pixel electrode 42 and the counter electrode 45; and an auxiliary capacitance 44 formed by the pixel electrode 42 and the auxiliary capacitance electrode 46. By the liquid crystal capacitance 43 and the auxiliary capacitance 44, a pixel capacitance 47 is formed. Note that the configuration of the pixel formation portion 4 is not limited to that shown in FIG. 4. For example, a configuration in which the auxiliary capacitance 44 and the auxiliary capacitance electrode 46 are not provided can also be adopted.

As for the TFT 41 in the pixel formation portion 4, typically, an oxide TFT (a thin film transistor having an oxide semiconductor layer) is adopted. The oxide semiconductor layer includes, for example, an In—Ga—Zn—O-based semiconductor such as indium gallium zinc oxide. The In—Ga—Zn—O-based semiconductor is a ternary oxide of In, Ga, and Zn. Note that TFTs other than an oxide TFT can also be used as the TFT 41 in the pixel formation portion 4.

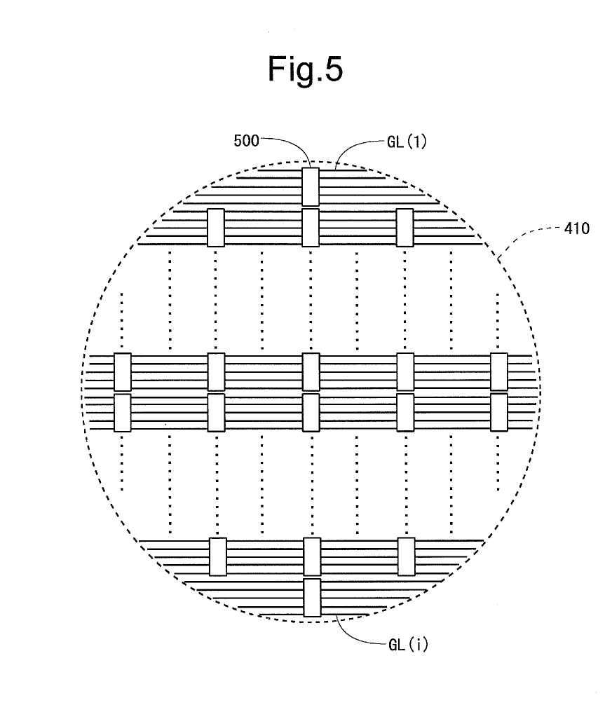

In addition, in the present embodiment, gate drivers (scanning signal line drive circuits) 500 that drive the gate bus lines GL are formed in the display unit 410 as shown in FIG. 5. Conventionally, a gate driver is provided in a picture-frame region (outside the display unit), and thus, scanning signals are provided from the picture-frame region into the display unit. On the other hand, in the present embodiment, scanning signals are outputted from the gate drivers 500 provided in the display unit 410. Since such a configuration is adopted, circuits and wiring lines for driving the gate bus lines GL do not need to be formed in the picture-frame region, enabling to implement an oddly shaped display such as that of the present embodiment.

An operation overview of the components shown in FIGS. 2 and 5 will be described below. The power supply 100 supplies a predetermined power supply voltage to the display control circuit 200, the source driver 300, and the liquid crystal panel 400 (more specifically, the gate drivers 500 in the liquid crystal panel 400). The display control circuit 200 receives an image signal DAT and a timing signal group TG such as a horizontal synchronizing signal and a vertical synchronizing signal, which are transmitted from an external source, and outputs digital video signals DV, and a source start pulse signal SSP, a source clock signal SCK, a latch strobe signal LS, a gate start pulse signal GSP, and a gate clock signal GCK which are for controlling image display on the display unit 410.

The source driver 300 receives the digital video signals DV, the source start pulse signal SSP, the source clock signal SCK, and the latch strobe signal LS which are outputted from the display control circuit 200, and applies data voltages V(1) to V(j) corresponding to display gradations indicated by the digital video signals DV to the source bus lines SL (1) to SL (j) (see FIG. 3). Note that a detailed description of the source driver 300 will be made later.

The gate drivers 500 repeat the application of active scanning signals to the respective gate bus lines GL (1) to GL (i), based on the gate start pulse signal GSP and the gate clock signal GCK which are outputted from the display control circuit 200, with one vertical scanning period being a cycle.

In the above-described manner, the data voltages V are applied to the source bus lines SL(1) to SL(j), respectively, and the scanning signals are applied to the gate bus lines GL (1) to GL(i), respectively, by which an image based on the image signal DAT transmitted from the external source is displayed on the display unit 410.

<2. Configuration and Operation of the Source Driver>

Next, the source driver 300 of the present embodiment will be described in detail.

<2.1 Overall Configuration of the Source Driver>

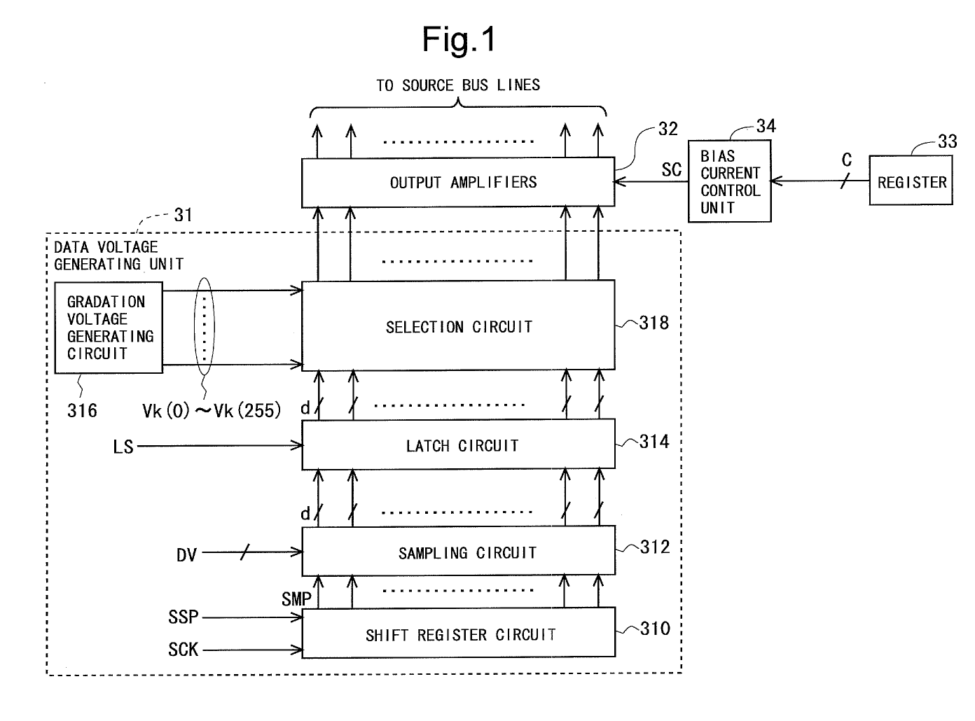

FIG. 1 is a block diagram showing a detailed configuration of the source driver 300 of the present embodiment. As shown in FIG. 1, the source driver 300 is composed of a data voltage generating unit 31, output amplifiers 32, a register (storage unit) 33, and a bias current control unit 34. The data voltage generating unit 31 includes a shift register 310 circuit, a sampling circuit 312, a latch circuit 314, a gradation voltage generating circuit 316, and a selection circuit 318.

A source start pulse signal SSP and a source clock signal SCK are inputted to the shift register circuit 310. The shift register circuit 310 sequentially transfers a pulse included in the source start pulse signal SSP from an input terminal to an output terminal, based on the source clock signal SCK. Sampling pulses SMP for the respective source bus lines SL(1) to SL(j) are sequentially outputted from the shift register circuit 310 according to this pulse transfer, and the sampling pulses SMP are sequentially inputted to the sampling circuit 312.

The sampling circuit 312 samples digital video signals DV transmitted from the display control circuit 200, at the timing of sampling pulses SMP outputted from the shift register circuit 310, and outputs the digital video signals DV as internal image signals d. The latch circuit 314 captures the internal image signals d outputted from the sampling circuit 312, at the timing of a pulse of a latch strobe signal LS, and outputs the internal image signals d.

The gradation voltage generating circuit 316 generates voltages (gradation voltages) corresponding to respective gradation levels, based on a plurality of reference voltages provided from the power supply 100, and outputs the voltages as a gradation voltage group. For example, voltages (gradation voltages) Vk(0) to Vk(255) corresponding to 256 gradation levels are outputted as a gradation voltage group from the gradation voltage generating circuit 316.

The selection circuit 318 selects anyone of the voltages included in the gradation voltage group outputted from the gradation voltage generating circuit 316, based on the internal image signals d outputted from the latch circuit 314, and outputs the selected voltages. The output amplifier 32 performs impedance transformation on the voltages outputted from the selection circuit 318, and outputs the transformed voltages as data voltages V to source bus lines SL. At that time, as will be described later, the magnitude of a bias current of each output amplifier 32 is controlled by the bias current control unit 34.

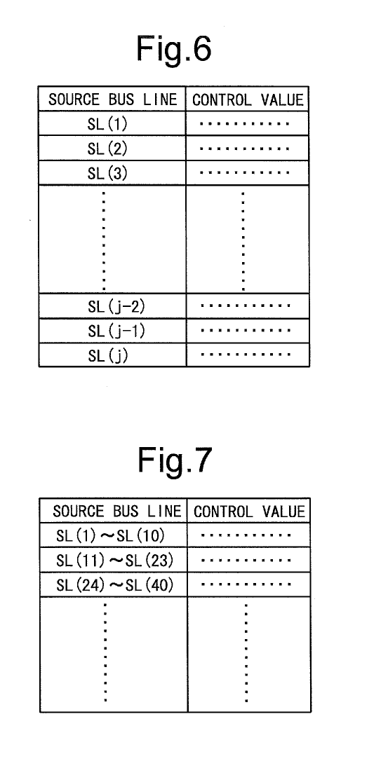

In the register 33 there are stored in advance control values C for adjusting the settling time of outputs of the data voltages V from the output amplifier 32. In the present embodiment, as shown in FIG. 6, the register 33 stores a control value C for each source bus line SL. Note, however, that the present invention is not limited thereto, and when it is OK to adjust the settling time on a per plurality of source bus lines SL basis, the register 33 may store a control value C for a plurality of source bus lines SL as shown in FIG. 7.

The bias current control unit 34 outputs, on a per source bus line SL basis, a bias current control signal SC based on a control value C stored in the register 33. By this bias current control signal SC, the magnitude of a bias current of an output amplifier 32 is controlled on a per source bus line SL basis.

<2.2 Configuration of the Output Amplifier>

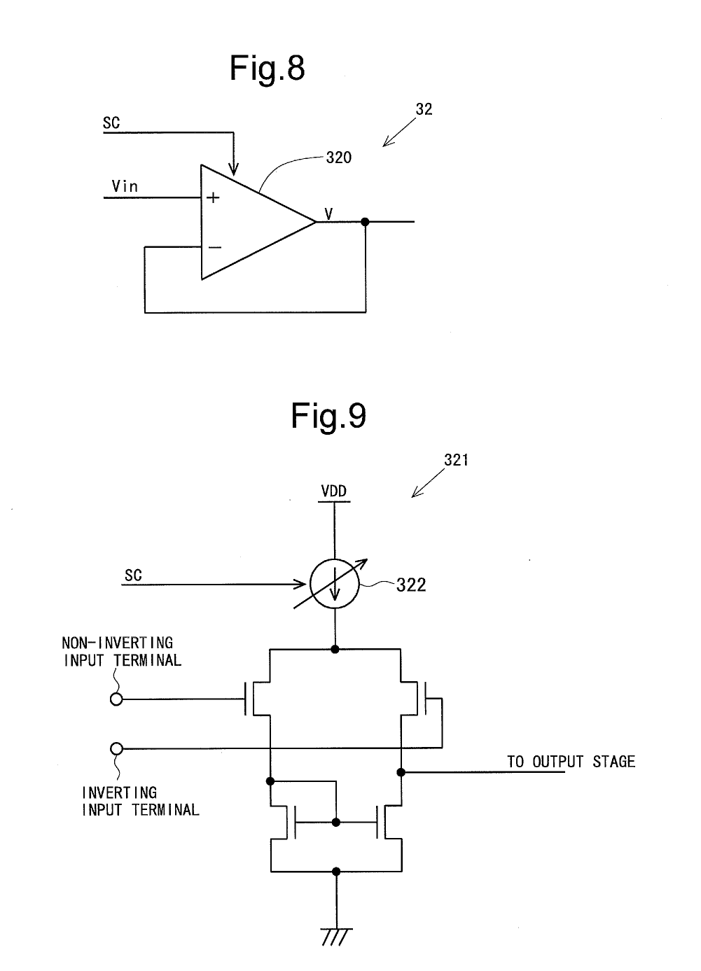

Next, with reference to FIGS. 8 to 10, a configuration of an output amplifier 32 corresponding to one source bus line SL will be described. As shown in FIG. 8, the output amplifier 32 includes an operational amplifier 320. A voltage (gradation voltage) Vin outputted from the selection circuit 318 (see FIG. 1) in the data voltage generating unit 31 is provided to a non-inverting input terminal of the operational amplifier 320. An output from the operational amplifier 320 is provided to an inverting input terminal of the operational amplifier 320. That is, negative feedback is applied to the operational amplifier 320. In addition, the output from the operational amplifier 320 is provided as a data voltage V to the source bus line SL. As described above, the output amplifier 32 of the present embodiment is a voltage follower circuit.

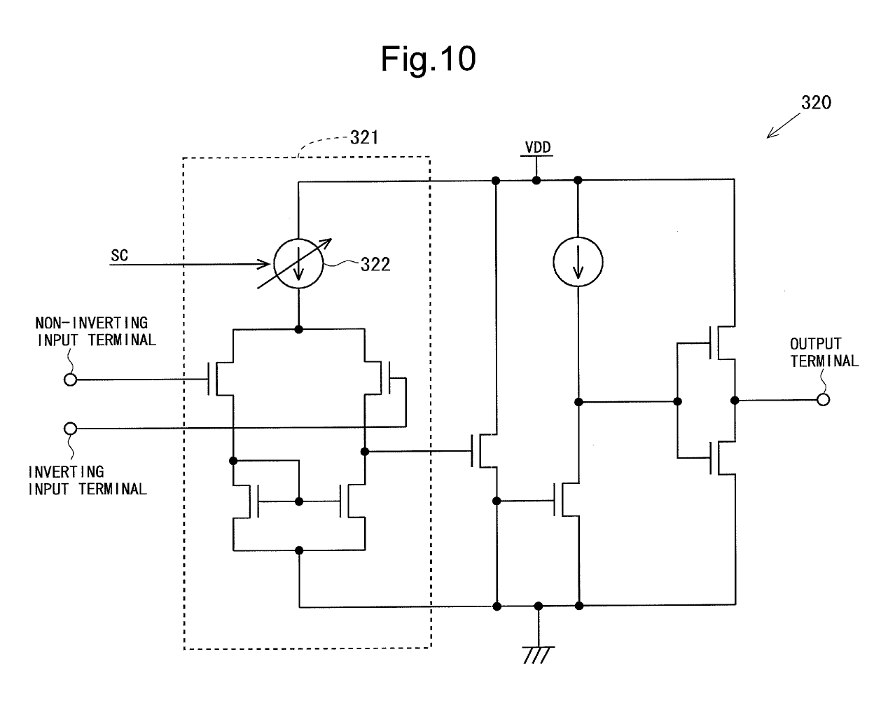

The operational amplifier 320 includes, for example, a differential amplifier 321 having a configuration such as that shown in FIG. 9. The differential amplifier 321 includes a variable constant-current source 322 that can control the magnitude of a constant current flowing through the circuit. The magnitude of a constant current supplied by the variable constant-current source 322 into the circuit is controlled by a bias current control signal SC provided from the bias current control unit 34 (see FIG. 1). By thus controlling the magnitude of a constant current flowing through the differential amplifier 321, the magnitude of a bias current of the output amplifier 32 changes. Note that an example of an overall configuration of the operational amplifier 320 is, for example, a configuration such as that shown in FIG. 10.

<3. Specific Example of Control of a Bias Current of the Output Amplifier>

Next, the control of a bias current of the output amplifier 32 will be more specifically described. Note that here it is assumed that the bias current control unit 34 is implemented by a D/A converter that can output voltages of eight levels. Note also that it is assumed that the magnitude of a bias current is controlled within a range of 20% to 150% with reference to 0.15 mA.

In the register 33 there is stored in advance a 3-bit value as a control value C, depending on a target magnitude of a bias current. The control value C stored in the register 33 is provided to the D/A converter (bias current control unit 34). The D/A converter outputs any one of the voltages of eight levels (eight voltages corresponding to “the magnitude of a bias current: 20%” to “the magnitude of a bias current: 150%”) as a bias current control signal SC, depending on the 3-bit value which is the control value C stored in the register 33. The voltage (the bias current control signal SC) outputted from the D/A converter is provided to the variable constant-current source 322 in the output amplifier 32 (see FIG. 9). By this, in the output amplifier 32, the magnitude of the constant current is controlled, and the magnitude of the bias current changes according to the magnitude of the constant current.

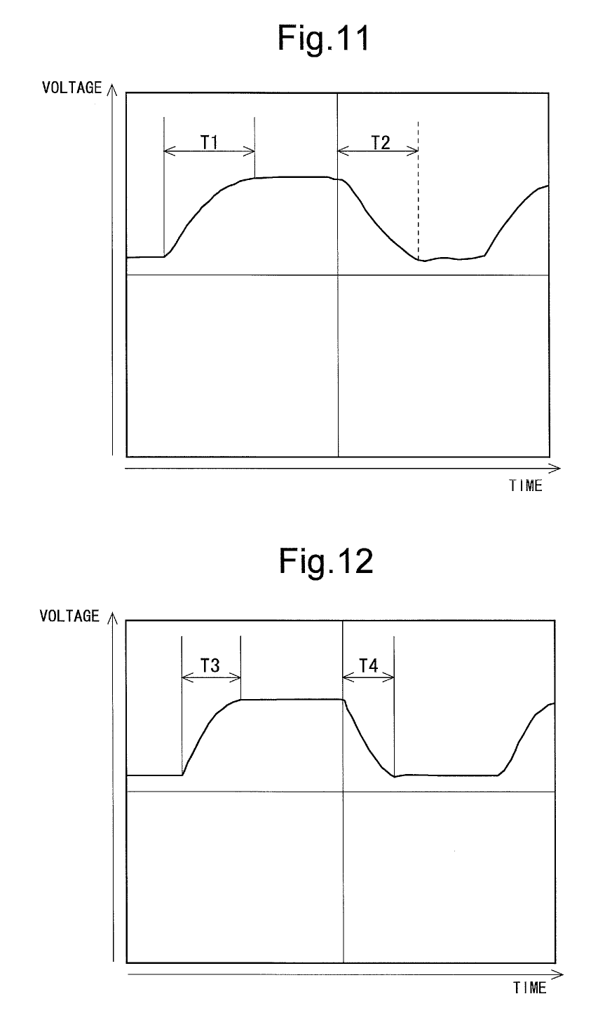

Meanwhile, focusing attention on one source bus line SL, the signal waveform of a data voltage V changes as shown in FIG. 11 in a case where the magnitude of the bias current of the output amplifier 32 is set to 40%, and the signal waveform of a data voltage V changes as shown in FIG. 12 in a case where the magnitude of the bias current of the output amplifier 32 is set to 100%. Here, focusing attention on a case in which the polarity of the data voltage V changes from negative polarity to positive polarity, settling time T3 for when the magnitude of the bias current is set to 100% (see FIG. 12) is shorter than settling time T1 for when the magnitude of the bias current is set to 40% (see FIG. 11). In addition, focusing attention on a case in which the polarity of the data voltage V changes from positive polarity to negative polarity, settling time T4 for when the magnitude of the bias current is set to 100% (see FIG. 12) is shorter than settling time T2 for when the magnitude of the bias current is set to 40% (see FIG. 11). As such, the larger the value of the bias current of the output amplifier 32, the shorter the settling time of the data voltage V.

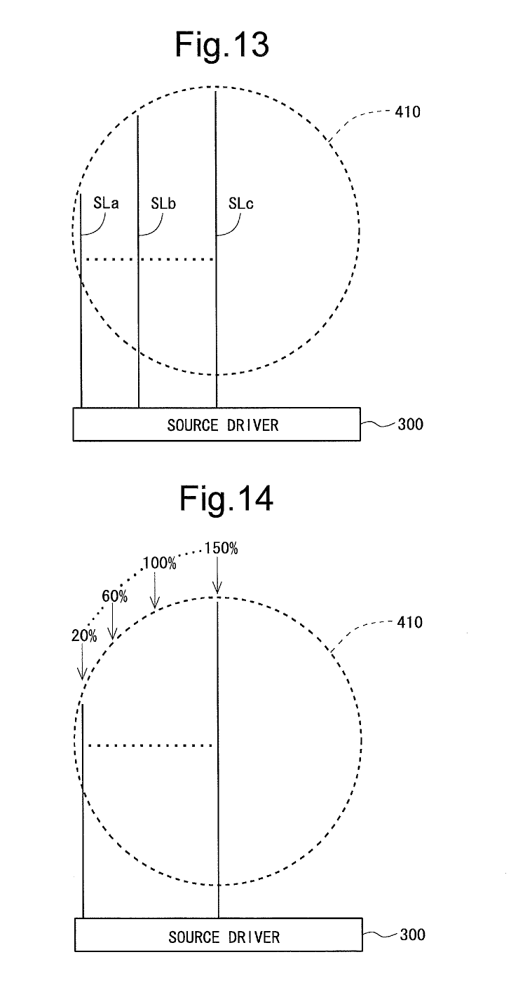

In addition, for example, regarding source bus lines shown in FIG. 13, a source bus line SLb is longer than a source bus line SLa, and a source bus line SLc is longer than the source bus line SLb. As such, the length of the source bus line SL increases as the disposition location thereof gets closer to a central portion of the display unit 410. Therefore, the load on the source bus line SL increases as the disposition location thereof gets closer to the central portion of the display unit 410.

Hence, in the present embodiment, the magnitude of a bias current is controlled such that a larger bias current flows through an output amplifier 32 provided for a source bus line SL disposed at a location closer to the central portion of the display unit 410 (i.e., a source bus line SL with a larger load). In other words, control values C are stored in the register 33 in advance such that a larger bias current flows through an output amplifier 32 provided for a source bus line SL disposed at a location closer to the central portion of the display unit 410. For example, as shown in FIG. 14, control values C are stored in the register 33 in advance such that the magnitude of a bias current is 20% in an output amplifier 32 corresponding to a source bus line SL disposed at an edge portion of the display unit 410, and the magnitude of a bias current is 150% in an output amplifier 32 corresponding to a source bus line SL disposed at the central portion of the display unit 410. By this, regardless of the magnitude of the load on the source bus lines SL, the settling time of outputs of data voltages V from the output amplifiers 32 approaches certain time. As a result, the occurrence of a difference in charging rate depending on location (location in the horizontal direction of the display unit 410) is suppressed, and the charging rate becomes uniform across the display unit 410.

<4. Effect>

According to the present embodiment, the source driver 300 is provided with the register 33 that stores control values C for adjusting the settling time of outputs of data voltages V from the output amplifiers 32; and the bias current control unit 34 that controls the magnitudes of bias currents of the output amplifiers 32 based on the control values C stored in the register 33. In such a configuration, in the register 33 there are stored control values C in advance such that a larger bias current flows through an output amplifier 32 provided for a source bus line SL with a larger load. By this, the difference in the settling time of the data voltage V between the plurality of source bus lines SL is reduced. As a result, the charging rate becomes uniform across the display unit 410, and the occurrence of abnormal display (display of an image called vertical gradation) is suppressed. As described above, according to the present embodiment, the source driver 300 that can suppress the occurrence of abnormal display caused by “the difference in the settling time of a data voltage V (to be applied to a source bus line SL)” depending on location of the source bus lines SL, and a liquid crystal display device including the source driver 300 are implemented.

Note that it is also possible to achieve a uniform charging rate by uniformly increasing the magnitudes of bias currents of all output amplifiers 32 regardless of the magnitude of the load on the source bus lines SL. However, by controlling the magnitudes of bias currents depending on the magnitude of the load on the source bus lines SL as in the present embodiment, the effect of a reduction in power consumption can also be obtained.

<5. Variants>

<5.1 First Variant>

In the above-described embodiment, the shapes of the liquid crystal panel 400 and the display unit 410 are circular. However, the shapes of the liquid crystal panel 400 and the display unit 410 are not particularly limited. Now, an example in which the present invention is applied to a liquid crystal display device for in-vehicle use will be described as a first variant.

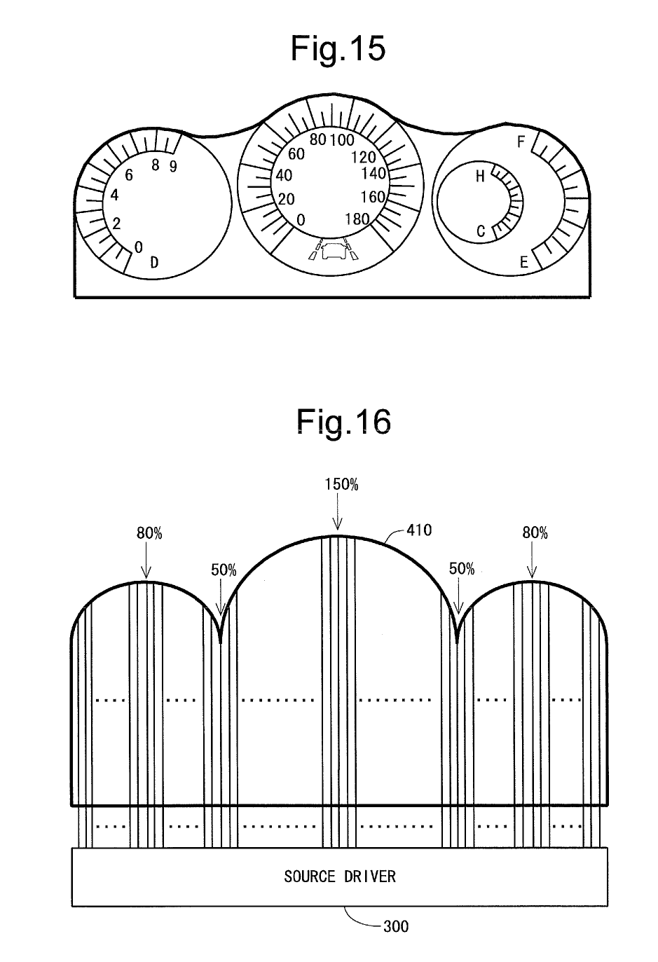

FIG. 15 is a front view of a liquid crystal display device for in-vehicle use according to the present variant. It can be grasped from an external appearance shown in FIG. 15 that the length of source bus lines varies depending on location. In the present variant, for example, as shown in FIG. 16, control values C are stored in the register 33 in advance such that a larger bias current flows through an output amplifier 32 provided for a source bus line SL with a larger load (a source bus line SL with a longer length). By this, as in the above-described embodiment, the charging rate becomes uniform across the display unit 410, and the occurrence of abnormal display (display of an image called vertical gradation) is suppressed.

<5.2 Second Variant>

In addition, although it is premised that the liquid crystal display device is an oddly shaped display in the above-described embodiment, the present invention is not limited thereto. Now, an example in which the present invention is applied to a liquid crystal display device having a general rectangular display unit will be described as a second variant.

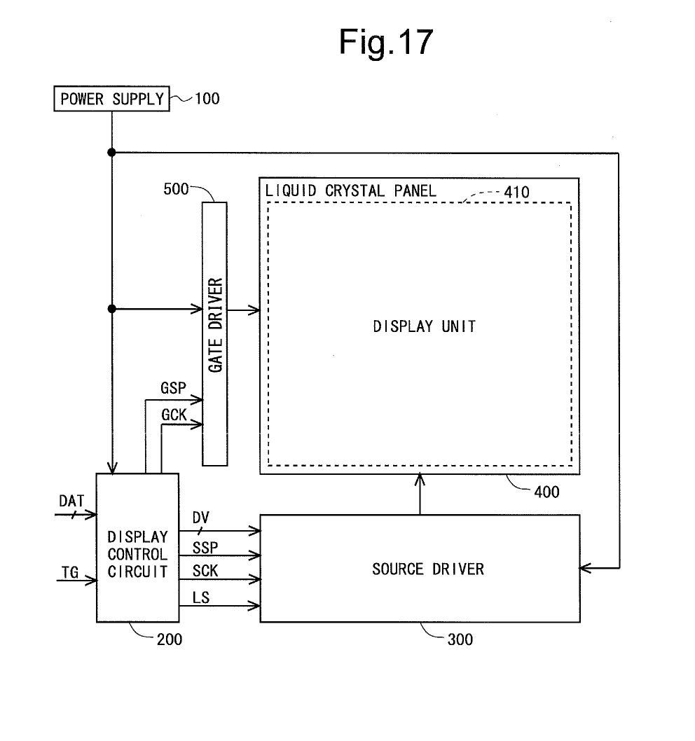

FIG. 17 is a block diagram showing an overall configuration of a liquid crystal display device according to the present variant. Unlike the above-described embodiment (FIG. 2), a gate driver 500 is provided outside the liquid crystal panel 400. Note that a gate driver 500 may be provided in a region outside the display unit 410 within the liquid crystal panel 400. The operation of components shown in FIG. 17 is the same as that of the above-described embodiment.

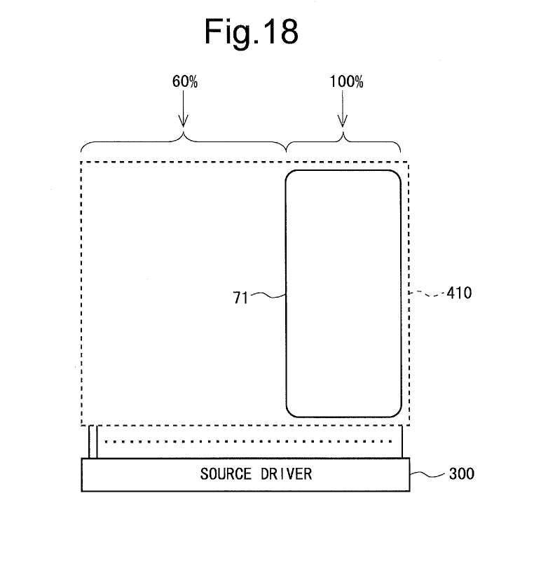

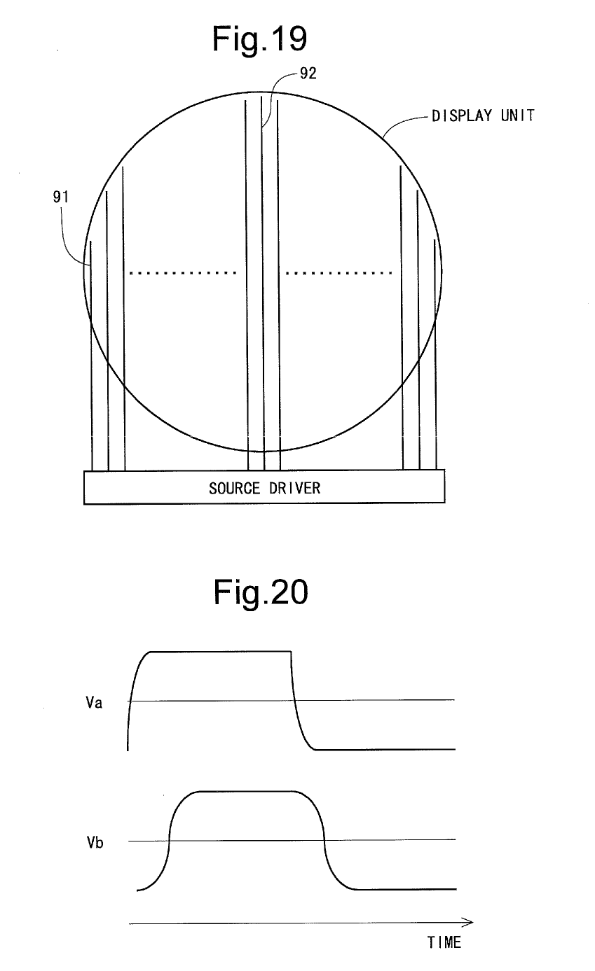

FIG. 18 only shows the source driver 300 and the display unit 410 among the components shown in FIG. 17. Here, it is assumed that, when so-called a solid image is displayed without controlling the magnitudes of bias currents of the output amplifiers 32, the luminance in a region denoted by reference character 71 in FIG. 18 is lower than that in other region. In such a case, in the present variant, control values C are stored in the register 33 in advance such that a larger bias current flows through output amplifiers 32 corresponding to source bus lines SL in the region denoted by reference character 71 than a bias current flowing through output amplifiers 32 corresponding to source bus lines SL in the region other than the region denoted by reference character 71. As an example, as shown in FIG. 18, control values C are stored in the register 33 in advance such that the magnitude of a bias current is 100% in the output amplifiers 32 corresponding to the source bus lines SL in the region denoted by reference character 71, and the magnitude of a bias current is 60% in the output amplifiers 32 corresponding to the source bus lines SL in the region other than the region denoted by reference character 71. As such, in the present variant, control values C are stored in the register 33 such that the magnitude of a bias current is increased more by the bias current control unit 34 for an output amplifier 32 provided for a source bus line SL whose charging rate is lower when it is assumed that data voltages V of the same magnitude are applied to all source bus lines SL without controlling the magnitudes of bias currents of the output amplifiers 32. By this, the occurrence of luminance non-uniformity is suppressed in the liquid crystal display device having the general rectangular display unit 410.

Note that the present invention can also be applied to a case in which a gate driver 500 is formed in a picture-frame region in an oddly shaped display.

<6. Others>

This application claims priority to Japanese Patent Application No. 2015-208591 titled “Video Signal Line Drive Circuit and Display Device Provided with Same” filed Oct. 23, 2015, the content of which is included herein by reference.

### DESCRIPTION OF REFERENCE CHARACTERS

31: DATA VOLTAGE GENERATING UNIT
32: OUTPUT AMPLIFIER
33: REGISTER
34: BIAS CURRENT CONTROL UNIT
200: DISPLAY CONTROL CIRCUIT
300: SOURCE DRIVER (VIDEO SIGNAL LINE DRIVE CIRCUIT)
320: OPERATIONAL AMPLIFIER
321: DIFFERENTIAL AMPLIFIER
322: VARIABLE CONSTANT-CURRENT SOURCE
400: LIQUID CRYSTAL PANEL
410: DISPLAY UNIT
500: GATE DRIVER (SCANNING SIGNAL LINE DRIVE CIRCUIT)
GL(1) to GL(i): GATE BUS LINE
SL(1) to SL(j): SOURCE BUS LINE
SC: BIAS CURRENT CONTROL SIGNAL
C: CONTROL VALUE

1. A video signal line drive circuit for driving video signal lines, the video signal line drive circuit comprising:
a data voltage generating unit configured to generate data voltages corresponding to display gradations;
a number of output amplifiers equal to a number of the video signal lines, the output amplifiers being configured to output the data voltages to the video signal lines;
a storage unit configured to store control values for adjusting settling time of outputs of the data voltages from the output amplifiers; and
a bias current control unit configured to control magnitudes of bias currents of the output amplifiers based on the control values stored in the storage unit.

2. The video signal line drive circuit according to claim 1, wherein
the storage unit stores a number of the control values equal to the number of the video signal lines, and
the bias current control unit controls, on a per video signal line basis, a magnitude of a bias current of a corresponding output amplifier based on a corresponding one of the plurality of control values stored in the storage unit.

3. A display device comprising:
a display panel having video signal lines; and
a video signal line drive circuit according to claim 2.

4. The display device according to claim 3, wherein
a shape of the display panel is non-rectangular, and
control values are stored in the storage unit such that a bias current control unit increases a magnitude of a bias current more for an output amplifier provided for a video signal line with a longer length.

5. The display device according to claim 4, wherein the shape of the display panel is circular.

6. The display device according to claim 4, wherein the display device is for in-vehicle use.

7. The display device according to claim 4, wherein
the shape of the display panel is rectangular, and
the control values are stored in the storage unit such that the bias current control unit increases a magnitude of a bias current more for an output amplifier provided for a video signal line whose charging rate is lower when it is assumed that data voltages of a same magnitude are applied to all the video signal lines without controlling magnitudes of bias currents of output amplifiers.

8. A method for driving video signal lines by a video signal line drive circuit having a number of output amplifiers equal to a number of video signal lines, the method comprising:
a data voltage generating step of generating data voltages corresponding to display gradations;
a data voltage outputting step of outputting the data voltages to the video signal lines from the output amplifiers; and
a bias current controlling step of controlling magnitudes of bias currents of the output amplifiers based on control values set in advance to adjust settling time of outputs of the data voltages from the output amplifiers.
